(19) United States
(12) Patent Application Publication
(10) Pub. No.: US 2012/0189088 A1
(43) Pub. Date: Jul. 26, 2012

(54) METHOD FOR DETERMINING THE ISOTOPE RATIO OF FISSILE MATERIAL

(75) Inventors: Claire Vaglio-Gaudard, Venelles (FR); Jean-Michel Girard, Aix en Provence (FR); Pierre Leconte, Aix en Provence (FR)

(73) Assignee: COMMISSARIAT A L'ENERGIE ATOMIQUE ET AUX ENE. ALT, Paris (FR)

(21) Appl. No.: 13/395,818

(22) PCT Filed: Sep. 27, 2010
(86) PCT No.: PCT/EP10/64220

§ 371 Date: Mar. 13, 2012

(30) Foreign Application Priority Data
Sep. 28, 2009 (FR) 0956692

(51) Int. Cl. G21C 17/00

(52) U.S. Cl. 376/245

(57) ABSTRACT

A method for determining isotope ratio of fissile material having a main isotope and at least one impurity isotope, including: measurement of net areas, at respective energies, of gamma peaks of the fissile material; measurement of the reference total absorption efficiencies at the energies; calculation of the total efficiency transfers of the fissile material; and calculation of the isotope ratio of fissile material.

### TECHNICAL FIELD AND PRIOR ART

The invention concerns a method for determining the isotope ratio of fissile material.

Measurement by fission chamber enables the power of a nuclear reactor to be identified or characteristic fission rates of a neutron flow at certain locations of the core to be obtained over a given energy range (case of a miniature fission chamber used in an experimental reactor to measure a flux attenuation value in a reflector, for example).

A fission chamber consists of a sealed enclosure filled with an inert gas with great ionising power. Fissile material is deposited inside the fission chamber on an element forming an anode, and the sealed enclosure forms a cathode. When the neutrons the flux of which is to be measured come into contact with the fissile material, fission occurs and two fission fragments are emitted, leaving at 180° relative to one another. One of the two fragments is stopped in the anode and the other ionises the gas before being stopped by the cathode. Ionisation of the gas leads to the creation of electrons in the fission chamber. The electrons created by ionisation are then collected by the cathode and transmitted to an electron processing line via a coaxial cable. The number of electrons created is directly proportional to the neutron flux having caused the fission.

Knowledge of the impurities present in a fission chamber is crucial for correct interpretation of the measurements. If the fissile material is, for example, Uranium ²³⁸U, it is possible that several tens of percent of the detected signal come from Uranium ²³⁵U impurities. It is thus necessary to know the ²³⁵U/²³⁸U isotope ratio with the greatest accuracy in order to be able to extract the useful signal from the detected signal. The uncertainty associated with knowledge of this isotope ratio must therefore be as low as possible, ideally of the order of several percent.

Several methods are currently known to determine this isotope ratio. The first method consists in dissolving the material concerned or a sample of this material, and in undertaking a chemical analysis of the dissolved material. By this method, it is possible to gain knowledge of the isotopy of the material with an accuracy of less than one percent. A major disadvantage of this method is its destructive character, since it destroys the material. In addition to its destructive character, another disadvantage of this method lies in the generation of effluents which must ultimately be processed.

Another method is neutron interrogation. Neutron interrogation has the advantage that it is not destructive. One disadvantage of neutron interrogation is, however, that it cannot be undertaken on a small quantity of material (a few hundreds of micrograms in the case of a miniature fission chamber).

Other methods are also known, such as, for example, calibration relative to a reference chamber, or use of different spectra and materials having particular neutron characteristics. These other methods have the disadvantage that they are difficult to implement and that they provide relatively imprecise results.

The invention does not have the disadvantages mentioned above. Indeed, the invention proposes to measure the isotope ratio by implementing a method which does not destroy the fission chamber, and the uncertainty of which is of the order of a few percent (typically less than 10%).

### ACCOUNT OF THE INVENTION

The invention concerns a method for determining the isotope ratio of fissile material contained in a fission chamber, where the fissile material has a main isotope X and at least one impurity isotope Y, and where isotopes X and Y have radioactive decays according to the following two equations:

X->X′ characterised by λₓ, Fₓ, and

Y->Y′ characterised by λ_{Y}, F_{Y},

where X′ and Y′ are respective “daughter” isotopes of isotopes X and Y, where the decay of isotope X (respectively Y) is characterised by the emission of a gamma particle by daughter isotope X′ (respectively Y′) at an energy E₁ (respectively E₂) with a probability of emission I_{γ}(E₁) (respectively I_{γ}(E₂)), where magnitudes λ_{X} and λ_{Y} are, respectively, the radioactive decay constant of main isotope X and the radioactive decay constant of impurity isotope Y, and where F_{X} and F_{Y} are, respectively, an isotope decay branching factor used for a measurement of main isotope activity and an isotope decay branching factor used for a measurement of impurity isotope activity.

The method is characterised in that it includes the following steps:

measurement, using a spectrometry bench put in a given measurement configuration, of a net area S(E₁) of a first gamma peak of the fissile material at a first energy E₁ and of a net area S(E₂) of a second gamma peak of the fissile material at a second energy E₂,

determination, using reference point sources, in the given measurement configuration, of a total reference absorption efficiency R_{O}^{P}(E₁) at first energy E₁ and of a total reference absorption efficiency R_{O}^{P}(E₂) at second energy E₂,

calculation, using a computer, in the given measurement configuration, of a total efficiency transfer T(E₁) of the fissile material at first energy E₁ and of a total efficiency transfer T(E₂) of the fissile material at second energy E₂, and

calculation, using a computer, of the isotope ratio of fissile material R using the following equation:

$$R = \frac{{λ}_{X}}{{λ}_{Y}} \times \frac{S ( {E}_{2} )}{S ( {E}_{1} )} \times \frac{{I}_{γ} ( {E}_{1} )}{{I}_{γ} ( {E}_{2} )} \times \frac{{R}_{0}^{P} ( {E}_{1} )}{{R}_{0}^{P} ( {E}_{2} )} \times \frac{T ( {E}_{1} )}{T ( {E}_{2} )} \times \frac{{F}_{X}}{{F}_{Y}}$$

The expression “spectrometry bench put in a given measurement configuration” means that the different elements which constitute the spectrometry bench are placed, relative to one another, according to a geometry which is not modified from one measurement to the next.

The net area measurements are made either before the fissile material is introduced into the fission chamber, or after the fissile material is introduced into the fission chamber. In the first case the measurements are made either on a sample of the block of fissile material, or on the block of fissile material in its entirety. In the second case the measurements are made on the fission chamber in its entirety.

The method of the invention advantageously allows easy and efficient determination of the isotope ratio of fissile material based on measurements of gamma radiation and on library data.

Also advantageously, the measurement of the net areas is made over a sufficiently long period, enabling a small measuring uncertainty to be obtained (the duration of measurements of the net areas is, indeed, between one hour and several weeks, for example between one hour and ten weeks).

### BRIEF DESCRIPTION OF THE FIGURES

Other characteristics and advantages of the invention will appear on reading the preferential embodiment made in reference to the attached figures, among which:

FIG. 1 represents a functional diagram of a device used for implementing the method of the invention;

FIG. 2 represents a functional diagram of the method of the invention;

FIG. 3 represents a detailed view of a first step of the method of the invention;

FIG. 4 represents a detailed view of a second step of the method of the invention; and

FIG. 5 represents a detailed view of a third step of the method of the invention.

### DETAILED ACCOUNT OF A PREFERENTIAL EMBODIMENT OF THE INVENTION

According to the preferential embodiment of the invention described below, the fissile material is Uranium ²³⁸U and the impurities consist of Uranium ²³⁵U. However, the invention concerns every other fissile material, and also every impurity associated with this other fissile material. The fissile material may be, for example, ²⁴⁰Pu, ²⁴²Pu, ²⁴³Am, ²³²Th and the associated impurity may be, for example, ²³⁹Pu, ²⁴¹Am, ²³³Th.

If the fissile material is Uranium ²³⁸U and if the impurities consist of Uranium ²³⁵U, isotope ratio R is given by the following equation (1):

$$R = \frac{{λ}_{U 238}}{{λ}_{U 235}} \times \frac{{A}_{U 235}}{{A}_{U 238}} \qquad ( 1 )$$

where A_{U238} and A_{U235} are, respectively, the activity of the Uranium ²³⁸U and the activity of the Uranium ²³⁵U and λ_{U238} and λ_{U235} are, respectively, the radioactive decay constant of Uranium ²³⁸U and the radioactive decay constant of Uranium ²³⁵U.

The decay scheme of Uranium ²³⁸U and of Uranium ²³⁵U is written as follows:

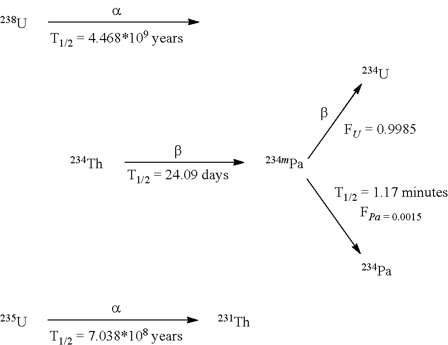

where the symbol “α” represents the decay by emission of α particles, the symbol “β” the decay by emission of β particles, T_{1/2} the half-life of the isotope concerned, F_{U} the decay branching factor of isotope ^{234m}Pa to ²³⁴U, i.e. the probability for Protactinium ^{234m}Pa that it will disintegrate into Uranium ²³⁴U and F_{Pa} the decay branching factor of isotope ^{234m}Pa to ²³⁴Pa, i.e. the probability for Protactinium ^{234m}Pa that it will disintegrate into Protactinium ²³⁴Pa (F_{U}+F_{Pa}=1).

At secular equilibrium (also called nuclear equilibrium), the decay scheme of Uranium ²³⁸U therefore leads to expressing activity A_{U238} of Uranium ²³⁸U in relation to activity A_{Pa234m} of the Protactinium ^{234m}Pa as follows:

$$\begin{matrix}{A}_{U 238} = \frac{1}{{F}_{U }} \times {A}_{P a 234 m} & ( 2 ) \\ Hence \text{:} R = \frac{{λ}_{U 238}}{{λ}_{U 235}} \times \frac{{A}_{U 235}}{{A}_{P a 234 m}} \times {F}_{U} & ( 3 )\end{matrix}$$

The two gamma rays traditionally measured to quantify the activities of Uranium ²³⁵U and of Protactinium ^{234m}Pa are the rays at 185.7 keV (intensity of 57.0%) and at 1001 keV (intensity of 0.839%). It is these two rays which are measured in connection with the preferential embodiment of the invention.

Activity A of any isotope calculated from the measurement of one of its emitted gamma rays of energy E₀ is given by the following formula:

$$A = \frac{S ( {E}_{0} ) {C}_{coinc} ( {E}_{0} )}{{I}_{γ} ( {E}_{0} ) {R}_{0}^{P} ( {E}_{0} ) T ( {E}_{0} ) Δ {t}_{act}} \qquad ( 4 )$$

where:

S(E₀) is the net area of the gamma peak at energy E₀, in the given measurement configuration;

C_{coinc} (E₀) is the correction of true coincidences (simultaneous detection of radiation emitted during a given radioactive disintegration), in the given measurement configuration;

I_{γ}(E₀) is the probability of emission or intensity of the gamma ray of energy E₀ for the daughter isotope of the isotope in question;

R₀^{P}(E₀) is the total reference absorption efficiency at energy E₀, which is obtained by calibration of the gamma detector using a reference point source, in the given measurement configuration;

T(E₀) is the total efficiency transfer which enables the solid angle and matrix effects in the given measurement configuration to be corrected (heterogeneity of the sources and gamma self-absorption due to the measurement of an object in a configuration different to that used during the calibration);

Δt_{act} is the active measurement duration, i.e. the corrected measurement duration of the electron dead time.

From the expression of A above, it follows that isotope ratio R for Uranium ²³⁸U is written:

$$R = \frac{{λ}_{U 238}}{{λ}_{U 235}} \times \frac{S ( 185.7 keV )}{S ( 1001 keV )} \times \frac{{I}_{γ} ( 1001 keV )}{{I}_{γ} ( 185 , 7 keV )} \times \frac{{R}_{0}^{P} ( 1001 keV )}{{R}_{0}^{P} ( 187 , 7 keV )} \times \frac{T ( 1001 keV )}{T ( 185 , 7 keV )} \times {F}_{U} \qquad ( 5 )$$

where:

λ_{U235} is a known datum in the international databases (λ_{U235}=ln (2)/(2.22102 10¹⁶) s⁻¹);

λ_{U238} is a known datum in the international databases (λ_{U238}=ln(2)/(1.40996 10¹⁷) s⁻¹);

S(185.7 keV) is a measured magnitude;

S(1001 keV) is a measured magnitude;

I_{Y} (1001 keV) is a known datum in the international databases (I_{Y} (1001 kev)=0.00839);

I_{Y}(185.7 keV) is a known datum in the international databases (I_{Y}(185.7 kev)=0.570);

R₀^{P}(1001 keV) is a magnitude measured by calibration;

R₀^{P}(185.7 keV) is a magnitude measured by calibration;

T(1001 keV) is a magnitude calculated by modelling;

T(185.7 keV) is a magnitude calculated by modelling;

F_{U} is a known datum in the international databases.

Equation (5) above concerns the case in which the fissile material is Uranium ²³⁸U (main isotope) and the impurity Uranium ²³⁵U (associated impurity isotope), and where the gamma rays used to quantify the activities of the main isotope and of the impurity isotope are respectively the rays at 1001 keV and 185.7 keV.

In the general case of a fissile material X (main isotope) and of an associated impurity Y (impurity isotope), where the gamma rays used to quantify the activities of the main isotope and of the impurity isotope are, respectively, a ray of energy E₁ and a ray of energy E₂, isotope ratio R is written:

$$R = \frac{{λ}_{X}}{{λ}_{Y}} \times \frac{S ( {E}_{2} )}{S ( {E}_{1} )} \times \frac{{I}_{γ} ( {E}_{1} )}{{I}_{γ} ( {E}_{2} )} \times \frac{{R}_{0}^{P} ( {E}_{1} )}{{R}_{0}^{P} ( {E}_{2} )} \times \frac{T ( {E}_{1} )}{T ( {E}_{2} )} \times \frac{{F}_{X}}{{F}_{Y}} \qquad ( 6 )$$

where:

λ_{X} is the radioactive decay constant of the main isotope of the fissile material to be installed in the fission chamber,

λ_{Y} is the radioactive decay constant of the impurity isotope associated with the main isotope,

S(E₁) is the net area of a first gamma peak of the fissile material at energy E₁ and S(E₂) the net area of a second gamma peak of the fissile material at energy E₂,

R_{O}^{P}(E₁) is the total reference absorption efficiency at energy E₁ and R_{O}^{P}(E₂) the total reference absorption efficiency at energy E₂,

T(E₁) is the total efficiency of the fissile material at energy E₁ and T(E₂) the total efficiency of the sample of the fissile material at energy E₂,

I_{Y}(E₁) and I_{Y}(E₂) are, respectively, the probability of emission of a gamma ray of the “daughter” of the main isotope at energy E₁ and the probability of emission of a gamma ray of the “daughter” of the impurity isotope at energy E₂,

F_{X} is the branching decay factor of an isotope used to measure the activity of the main isotope, and

F_{Y} is the branching decay factor of an isotope used to measure the activity of the impurity isotope.

As was mentioned above, with the example of Uranium ²³⁸U and of Uranium ²³⁵U, the decay branching factors are known probabilities relating to the mode of disintegration of the isotopes. If the isotope used to measure the activity disintegrates unequivocally, the decay branching factor is equal to 1 and, if the disintegration is not unequivocal, the branching factor is equal to the probability associated with the chosen disintegration.

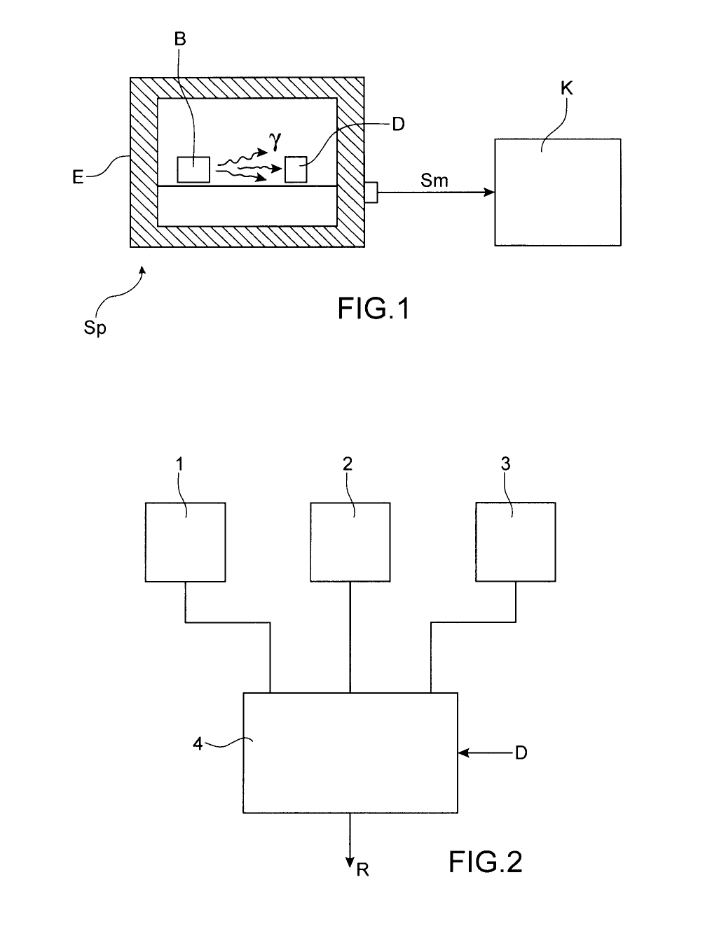

FIG. 1 represents a functional diagram of a device used for implementing the method of the invention.

The device includes a gamma spectrometry bench Sp and a computer K.

Gamma spectrometry bench Sp delivers measurement signals Sm which are transmitted to computer K. Spectrometry bench Sp consists of an enclosure E in which a detector D is placed. Detector D, which is preferentially a germanium diode of great purity, is a gamma ray detector which is satisfactorily efficient over a wide energy range, for example energies ranging from 50 keV to 2 MeV. Detector D is also preferentially able to limit the Compton effect. Fissile material is placed in enclosure E. Reference B in FIG. 1 represents this fissile material: this is either a sample of the block of fissile material intended to be installed in the fission chamber, or the block of fissile material itself, or the fission chamber in its entirety with the block of fissile material installed in it. The interaction of the gamma rays emitted from fissile material B with detector D leads to ionisation of the atoms of the detector medium. The charges created in this manner are collected by a high-voltage DC power supply, for example a power supply of several thousands of volts (not represented in FIG. 1). Enclosure E is preferentially a circular enclosure, consisting of materials enabling a very low background noise to be obtained, for example, a stack of low-activity lead, of ultra-low-activity lead, tin and copper. The detector is cooled by a cryo-cycle system which allows electric/liquid nitrogen hybrid cooling. This system allows acquisition periods of several weeks without any disturbance relating to the addition of liquid nitrogen.

The measurement signals Sm determined from the gamma radiation are transmitted to computer K for processing. Computer K uses processing methods able to deliver the desired magnitudes.

The method of the invention will now be described with reference to FIGS. 2-5.

The method of the invention includes (cf. FIG. 2) a step 1 of determination of the net areas S(185.7 keV) and S(1001 keV) of the fissile material, a step 2 of determination of the total reference absorption efficiencies at energies of 185.7 keV and 1001 keV, R₀^{P}(185.7 keV) and R₀^{P}(1001 keV) , a step 3 of determination of the total efficiency transfers at energies 185.7 keV and 1001 keV, T(185.7 keV) and T(1001 keV), and a step 4 of calculation of isotope ratio R from the results of steps 1, 2 and 3 and from known data D taken from data libraries. Data D is the previously defined data λ_{U238}, λ_{U235}, I_{Y} (185.7 keV), I_{Y}(1001 keV) and F_{U}.

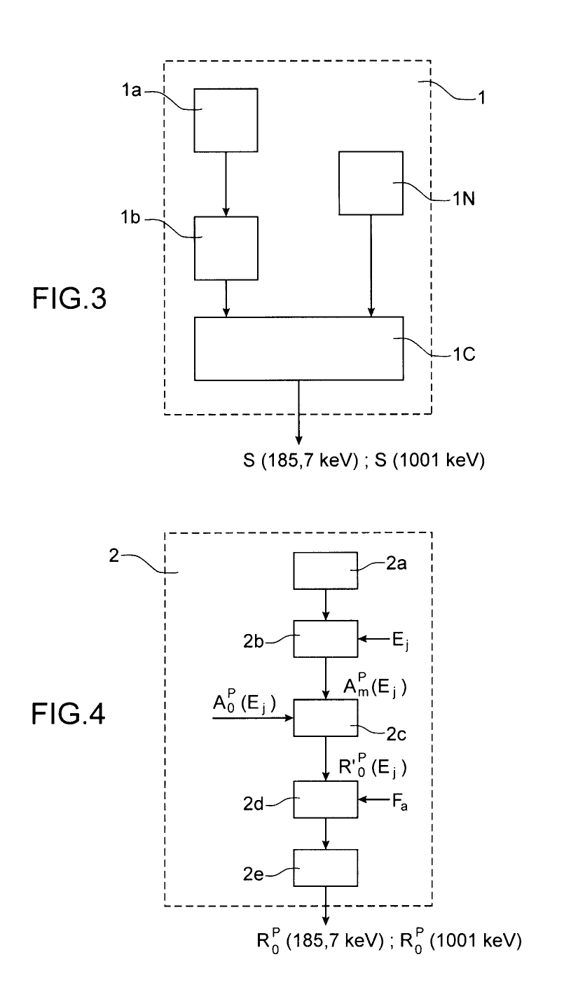

Step 1 of determination of the net areas S(185.7 keV) and S(1001 keV) includes a step 1a of measurement of the gamma spectrum of fissile material B. Measurement of the gamma spectrum is undertaken, using measuring bench Sp, over an energy band which includes the useful rays at 185.7 keV and 1001 keV. Step 1a (FIG. 3) is followed by a step 1b of extraction, using computer K, of the net areas of the rays at 185.7 keV and 1001 keV. A measurement of the gamma background noise is also made, using measuring bench Sp, over the same energy band in step 1N, to measure any gamma peaks of the background noise at energies E₁ and E₂ which are superimposed on the peaks determined in the measurement of step 1a. Using the results obtained on conclusion of steps 1b and 1N, computer K calculates, in step 1c, net areas S(185.7 keV) and S(1001 keV). The calculation application used to calculate the net areas is, for example, the application GENIE2000, the user manual of which is available on the Internet network at the following Web address:

http://www.ipnas.ulg.ac.be/garnir/pdf/genie2000.pdf,

Every other type of application known to the skilled man in the art which can produce the desired result can also be used.

FIG. 4 illustrates the different elementary steps which comprise step 2 of determination of the total reference absorption efficiencies at energies 185.7 keV and 1001 keV, R₀^{P}(185.7 keV) and R₀^{P}(1001 keV).

Step 2 of determination of the total reference absorption efficiencies R₀^{P}(185.7 keV) and R₀^{P}(1001 keV) is a step known in the art. Step 2 starts with a step 2a of the choice of point sources, the activities of which are well known. Each point source j is characteristic of an emission of gamma particles at an energy Eⱼ chosen from a known energy range, for example the range 50 keV−2 MeV.

Each point source j is placed in the enclosure to measure its activity (step 2b). The activity Aₘ^{P}(Eⱼ) of each point source j at energy Eⱼ is then measured using measuring bench Sp and computer K. The total reference absorption efficiency R′₀^{P}(Eⱼ) of each point source at energy Eⱼ is then calculated, in step 2c, from the measured activity Aₘ^{P}(Eᵢ) and from the activity of the point source knowledge of which is a given, Aₒ^{P}(Eᵢ). This gives the following:

R′ₒ^{P}(Eⱼ)=Aₘ^{P}(Eⱼ)/Aₒ^{P}(Eⱼ),

A curve is then obtained of the total reference absorption efficiencies R′₀^{P}(Eⱼ) for the different energies Eⱼ. The curve of the efficiencies R′₀^{P}(Eⱼ) is then adjusted, using an analytical function Fa, by computer K (step 2d). Analytical function Fa consists, for example, in expressing the Napierian logarithm R′ₒ^{P} as a function of a polynomial of a Napierian logarithm of the energy. From the adjusted curve delivered in step 2d the values of the total reference absorption efficiencies at the desired energies of 185.7 keV and 1001 keV, R₀^{P}(185.7 keV) and R₀^{P}(1001 keV), are deduced.

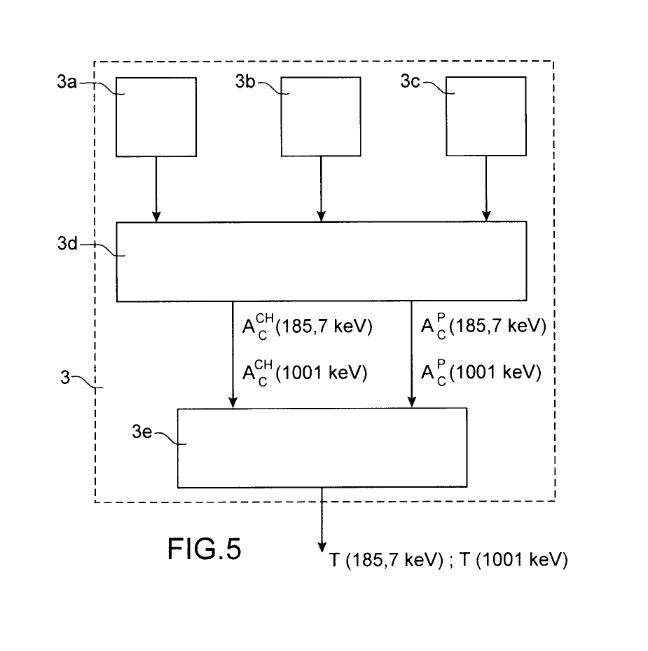

FIG. 5 illustrates the different elementary steps comprising step 3 of determination of the total efficiency transfers.

Step 3 of determination of the total efficiency transfers includes, firstly, a step 3a of modelling of the measuring bench equipped with detector D, a step 3b of modelling of the element measured in step 1 of determination of the net areas (fission chamber CH or sample of block of fissile material) and a step 3c of modelling of the conditions of use of the point source used in the measurement of the absorption efficiencies in the same measurement configuration of the gamma bench as in step 3b. From the modelling data delivered on conclusion of steps 3a and 3b, a step of calculation 3d calculates, for example using the Monte Carlo method for the resolution of the photon transmission equation, the relative activity of the modelled element determined by detector D modelled in the calculation at the respective energies of 185.7 keV and 1001 keV, namely magnitudes A_{C}^{CH}(185.7 keV) and A_{C}^{CH} (1001 keV). Similarly, from the modelling data delivered on conclusion of steps 3a and 3c, a step of calculation 3d calculates, for example using the Monte Carlo method, the relative activity of the point source determined by detector D modelled in the calculation at the respective energies of 185.7 keV and 1001 keV, namely magnitudes A_{C}^{P}(185.7 keV) and A_{C}^{P}(1001 keV).

On conclusion of step 3d, a step of calculation 3e calculates magnitudes T(185.7 keV) and T(1001 keV) from the calculated activities, namely:

T(185.7 keV)=A_{C}^{CH} (185.7 keV) /A_{C}^{P} (185.7 keV)

T(1001 keV)=A_{C}^{CH} (1001 keV)/A_{C}^{P}(1001 keV)

From all the magnitudes determined as described above and from the previously mentioned library data, it is then possible to determine isotope ratio R such that:

$$R = \frac{{λ}_{U 238}}{{λ}_{U 235}} \times \frac{S ( 185.7 keV )}{S ( 1001 keV )} \times \frac{{I}_{γ} ( 1001 keV )}{{I}_{γ} ( 185 , 7 keV )} \times \frac{{R}_{0}^{P} ( 1001 keV )}{{R}_{0}^{P} ( 185 , 7 keV )} \times \frac{T ( 1001 keV )}{T ( 185 , 7 keV )} \times {F}_{U}$$

or, in the general case:

$$R = \frac{{λ}_{X}}{{λ}_{Y}} \times \frac{S ( {E}_{2} )}{S ( {E}_{1} )} \times \frac{{I}_{γ} ( {E}_{1} )}{{I}_{γ} ( {E}_{2} )} \times \frac{{R}_{0}^{P} ( {E}_{1} )}{{R}_{0}^{P} ( {E}_{2} )} \times \frac{T ( {E}_{1} )}{T ( {E}_{2} )} \times \frac{{F}_{X}}{{F}_{Y}} .$$

1-6. (canceled)

7. A method for determining an isotope ratio of fissile material contained in a fission chamber, wherein the fissile material has a main isotope X and at least one impurity isotope Y, and wherein isotopes X and Y have radioactive decays according to the following two equations:
X->X′ characterised by λₓ, Fₓ, and
Y->Y′ characterised by λ_{Y}, F_{Y},
where X′ and Y′ are respective daughter isotopes of isotopes X and Y, wherein the decay of isotope X (respectively Y) is characterised by emission of a gamma particle by daughter isotope X′ (respectively Y′) at an energy E₁ (respectively E₂) with a probability of emission I_{γ}(E₁) (respectively I_{γ}(E₂)), where magnitudes λ_{X} and λ_{Y} are, respectively, the radioactive decay constant of main isotope X and the radioactive decay constant of impurity isotope Y, and wherein F_{X} and F_{Y} are, respectively, an isotope decay branching factor used for a measurement of main isotope activity and an isotope decay branching factor used for a measurement of impurity isotope activity, the method comprising:
measurement, using a spectrometry bench put in a given measurement configuration, of a net area S(E₁) of a first gamma peak of the fissile material at a first energy E₁ and of a net area S(E₂) of a second gamma peak of the fissile material at a second energy E₂;
determination, using reference point sources, in the given measurement configuration, of a total reference absorption efficiency R_{O}^{P}(E₁) at the first energy E₁ and of a total reference absorption efficiency R_{O}^{P}(E₂)at the second energy E₂;
calculation, using a computer, in the given measurement configuration, of a total efficiency transfer T(E₁) of the fissile material at the first energy E₁ and of a total efficiency transfer T(E₂) of the fissile material at the second energy E₂; and
calculation, using a computer, of the isotope ratio of fissile material R using the following equation:
$$R = \frac{{λ}_{X}}{{λ}_{Y}} \times \frac{S ( {E}_{2} )}{S ( {E}_{1} )} \times \frac{{I}_{γ} ( {E}_{1} )}{{I}_{γ} ( {E}_{2} )} \times \frac{{R}_{0}^{P} ( {E}_{1} )}{{R}_{0}^{P} ( {E}_{2} )} \times \frac{T ( {E}_{1} )}{T ( {E}_{2} )} \times \frac{{F}_{X}}{{F}_{Y}} .$$

8. A method according to claim 7, in which the measurements of net area of the fissile material are made, before the fissile material is introduced into the fission chamber, on a sample of the block of fissile material intended to be installed in the fission chamber.

9. A method according to claim 7, in which the measurements of net area of the fissile material are made, before the fissile material is introduced into the fission chamber, on the block of fissile material intended to be installed in the fission chamber.

10. A method according to claim 7, in which the measurements of net area of the fissile material are made, after the fissile material is introduced into the fission chamber, on the fission chamber in its entirety.

11. A method according to claim 7, in which the main isotope is Uranium ²³⁸U and the impurity isotope is Uranium ²³⁵U.

12. A method according to claim 7, in which duration of the measurement of net area is between one hour and ten weeks.
